(19) United States
(12) Patent Application Publication
(10) Pub. No.: US 2017/0008999 A1
(43) Pub. Date: Jan. 12, 2017

(54) SELF-HEALING ELASTOMER AND PROCESS FOR ITS PREPARATION

(71) Applicant: FUNDACIÓN CIDETEC, Donostia-san Sebastián (ES)

(72) Inventors: Ibon ODRIOZOLA, Donostia-san Sebastián (ES); Alaitz REKONDO, Donostia-san Sebastián (ES); Roberto MARTIN, Donostia-san Sebastián (ES); Alaitz RUIZ DE LUZURIAGA, Donostia-san Sebastián (ES); Germán CABAÑERO, Donostia-san Sebastián (ES); Hans-jürgen GRANDE, Donostia-san Sebastián (ES)

(21) Appl. No.: 15/116,502

(22) PCT Filed: Feb. 28, 2014
(86) PCT No.: PCT/EP2014/053925

§ 371 Date: Aug. 3, 2016

(51) Int. Cl. C08G 18/38; C09J 175/08; C08G 18/48; C08G 18/24; C08G 18/75

(52) U.S. Cl. CPC C08G 18/3863; C08G 18/242; C08G 18/755; C08G 18/4845; C09J 175/08

(57) ABSTRACT

The self-healing cross-linked polymer comprises units of formula (I), wherein: P is a polymeric chain, R₁ and R₁′ are independently selected from the group consisting of: —H, (C₁-C₂₀)alkyl, (C₅-C₁₄)aryl, —OR₄, —(CO)R₅, —O(CO)R₆, —(SO)R₇, —NH—CO—R₈, —COOR₉, —NR₁₀R¹¹, —NO₂, and halogen; R₂, R₂′, R₃ and R₃′ are independently selected from the group consisting of: —H, (C₁-C₂₀)alkyl and (C₅-C₁₄)aryl; R₄ to R₁₁ are the same or different, and are selected from the group consisting of: —H, (C₁-C₂₀)alkyl, and (C₅-C₁₄)aryl; m is from 3 to 4; n is from 1 to 2; provided that n+m is 5; the polymer having H-bonding interactions and being able to undergo catalyst free aromatic disulfide metathesis at room-temperature, and having a tensile strength value from 0.5 to 1.5 MPa and an elongation at break value higher than 200% at room-temperature.

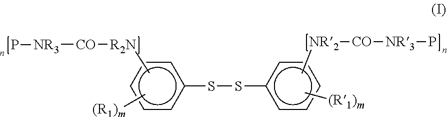

The present invention relates to the field of polymer chemistry, more particularly to self-healing materials. In particular, the invention relates to a self-healing polymer and to a process for its preparation. The invention also relates to the use of the new self-healing polymer.

### BACKGROUND ART

Upon long-term exposure to environmental conditions, polymeric materials usually degrade and eventually fail. Mechanical failure of polymeric materials, such as elastomers, is often the result of crack formation and propagation. To solve this problem, several intriguing approaches have been developed to creating self-healing or healable polymers, which have the ability to repair themselves autonomously (self-healing materials), or can be healed upon exposure to an external stimulus such as heat, light, pressure or mechanical stress (healable materials).

A self-healing or healable polymer must possess the ability to form multiple bonding interactions in and around the damaged area, creating connections between the components that make up its structure. To date, this challenge has been treated with four different strategies: (a) encapsulation of reactive monomers that are released after a fracture, (b) the formation of new irreversibly covalent bonds in the damaged area, (c) supramolecular self-assembly, and (d) the formation of reversible covalent bonds.

Encapsulation of monomers has been used successfully for some applications, but the irreversible nature of the healing mechanism is a limitation, as the repair can occur only once in the same place. The same applies for irreversible covalent bonds that are induced in the damaged area. A particularly useful approach to generate self-healing or healable polymers has been the introduction of reversible or exchangeable bonds into the polymer network. The idea behind this is to reconnect the chemical crosslinks which are broken when a material fractures, restoring the integrity of the material. This is expected to provide polymers with enhanced lifetime and fatigue resistance. Self-healing approaches based on such dynamic crosslinks have been carried out using both reversible covalent chemistries and supramolecular interactions.

One representative example is the supramolecular self-healing elastomeric material developed by Leibler and co., based on H-bonding interactions. However, the stronger nature of dynamic covalent bonds compared to non-covalent ones, offers the possibility to obtain self-healing polymer networks with superior mechanical strength.

Diels-Alder, transesterification, olefin metathesis, radical reshuffling, imine or hydrazone formation, siloxane equilibration and aliphatic disulfide exchange are some examples of reversible covalent chemistries used for the design of healable polymers. In the majority of these cases, an external stimulus such as pH, or a source of energy such as heat or light is required, in order to promote reshuffling of such reversible chemical bonds. This fact greatly limits their practical application; in most cases it would not be possible to heal the material while it is in use, being necessary to dismantle the component to be repaired in order to apply the necessary stimulus.

WO2010128007A1 discloses a self-healing polymer comprising disulfide bonds, wherein self-healing is achieved by interchange reaction via the disulfide-bonds. Nevertheless, healing is only achieved after heating at temperatures higher to 60° C.

While various self-healing materials have heretofore been disclosed in the literature, there continues being a need of a polymer system with self-healing properties.

### SUMMARY OF THE INVENTION

The inventors of the present invention have developed a permanently cross-linked material, based on a covalently cured elastomeric network which, after being cut, is able to self-mend by simple contact at room-temperature.

Surprisingly, the developed cross-linked material of the present invention is a spontaneously self-healing thermoset elastomer presenting a quantitative healing efficiency without the addition of neither a specific catalyst nor an external stimulus such as heat or light.

In particular, it has been found that the self-healing process of the polymer of the invention takes place in a reduced period of time and without the need of any external stimulus, such as heat, light, or catalyst. So, when the polymer is cut into two pieces it restores again, in some cases even in a question of seconds, by just putting the pieces in contact together. FIG. 1 shows a photographic sequence of a typical healing process. First, a pristine cylinder made from the polymer composition of the first aspect of the invention was cut in half with a knife. Then the two halves were put in contact and allowed to stand at room-temperature, without applying any pressure. After 2 hours it was already not possible to separate the two pieces by stretching manually.

On the other hand, the self-healing efficiency of the polymer of the invention was quantified by tensile strength measurements. As it is shown in Table 1 the original material exhibited a tensile strength of 0.81±0.05 MPa and an elongation at breaking point of 3100±50%. After 1 hour of contact, the mended samples recovered 62% of their initial mechanical properties. At 2 h, the recovery was already 80%. The mended samples after 24 h showed a tensile strength of 0.77±0.05 MPa and an elongation at breaking point of 3015±50%. This means that a healing efficiency of 97% was achieved, which can be considered a quite remarkable result for a thermoset elastomeric material.

In view of the above, therefore, the present invention provides, in a first aspect, a self-healing cross-linked polymer comprising units of formula (I)

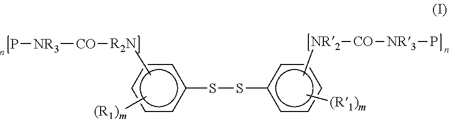

wherein
P is a polymeric chain,
R₁ and R₁′ are independently selected from the group consisting of: —H, (C₁-C₂₀)alkyl, (C₅-C₁₄)aryl, —OR₄, —(CO)R₅, —O(CO)R₆, —(SO)R₇, —NH—CO—R₈, —COOR₉, —NR₁₀R₁₁, —NO₂, and halogen;
R₂, R₂′, R₃ and R₃′ are independently selected from the group consisting of: —H, (C₁-C₂₀)alkyl and (C₅-C₁₄)aryl;
R₄ to R₁₁ are the same or different, and are selected from the group consisting of: —H, (C₁-C₂₀)alkyl, and (C₅-C₁₄)aryl;
m is from 3 to 4;
n is from 1 to 2; provided that n+m is 5;
the polymer having H-bonding interactions between the urea groups and being able to undergo catalyst free aromatic disulfide metathesis at room-temperature, and having a tensile strength value from 0.5 to 1.5 MPa and an elongation at break value equal or higher than 200% at room-temperature.

The properties shown by the polymer of the present invention are based on a) the metathesis reaction of aromatic disulfides, which exchange at room-temperature, unlike their aliphatic counterparts, which require heat or light in order the metathesis to occur; and b) the reversible H-bonding interactions between neighboring urea groups.

Among covalent bonds that are susceptible to undergo reversible exchange at room-temperature, metathesis of aromatic disulfides of general formulas (I), (II) and (III) offer unique opportunities, due to their simplicity and availability. Metathesis of aromatic disulfides has been reported to occur at room-temperature both in solution and in the solid state using a tertiary amine as catalyst.

Surprisingly, and contrary to the teachings of the prior art, the present invention provides, for the first time, a polymer with self-healing properties based on the aromatic disulfide methathesis without the presence of a catalyst.

WO2010128007 discloses self-healing crosslinked polymers using as curing agent Tetrathiol or Thioplast G21. In both cases, the self-healing behavior was observed when the temperature raises 60° C.

Contrary to the teachings of WO2010128007, the present invention provides a self-healing polymer composition which does not require the provision of heat or light. This is of great importance because it would be possible to heal the material while it is in use, not being necessary to dismantle the component to be repaired in order to apply the necessary stimulus.

In a second aspect, the present invention provides a process for preparing a self-healing polymer as defined in the first aspect of the invention, the process comprising the step of reacting an isocyanate-functionalised polymer with functionality equal or higher than 2 with an aromatic disulfide of general formula (II)

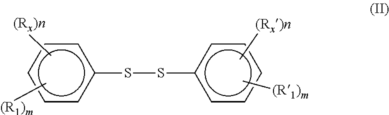

wherein
R₁, R₁′, n and m are as defined in claim 1,
Rₓ and Rₓ′ are the same or different and represent —NHR_{y},
R_{y} is selected from the group consisting of —H, (C₁-C₂₀)alkyl, —and (C₅-C₁₄)aryl;
   or alternatively,
   the step of reacting a primary or secondary amine-functionalised polymer with functionality equal or higher than 2 with an aromatic disulfide of formula (III)

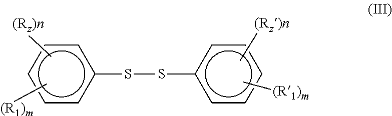

wherein
R₁, R₁′, n and m are as defined in claim 1,
R_{z} and R_{z}′ represents —N(CO),
   the reaction being performed, in any of the alternatives, at a temperature comprised from −30 to 200° C. and wherein the molar ratio between amine and isocyanate groups is from 1.2 to 1.8.

Until now, the prior art had disclosed process for preparing (urea-urethane) polymers, wherein there was an excess of isocyanate over amine groups. However, the resulting polymers following such processes of the prior art did not show the self-healing property.

Surprisingly, the present inventors have found that when the process is performed using an excess of amine groups over the isocyanate groups, in the specified molar ratio range, it is achieved a polymer which is self-healable at room temperature, without the need of any external stimuli.

The self-healing polymer network of the invention can also be defined by its preparation process. Thus, in a third aspect the present invention provides a self-healing material obtainable by the process of the invention described above. The term “obtainable” and “obtained” have the same meaning and are used interchangeably. In any case, the expression “obtainable” encompasses the expression “obtained”.

In view of the above, the polymer of the first aspect of the invention shows adhesive properties at room-temperature.

Therefore, in a fourth aspect the present invention provides the use of the polymer composition of the first aspect of the invention as an adhesive. In addition to the above, it was confirmed that the self-healing polymer network of the invention can stand an elongation of 100% for at least 24 hours following ISO 11600. In fact, as it is shown below, the material of the invention shows an elongation at break superior to 1000% when it is tested following ISO 527. This means that the original size can be increased 10-fold without breaking. This feature is of great importance in some fields such as construction sector, wherein the ISO11600 requirements specify that a material can only be used as a construction sealant when it can stand an elongation of 100% for at least 24 hours without breaking.

Therefore, in view of the above, the present invention provides the use of the polymer composition as defined in the first aspect of the invention as construction sealant.

In another aspect, the invention relates to an article of manufacture made of the polymer composition of the invention.

In still another aspect, the invention relates to a process for the manufacture of an article as defined above, the process comprising forming the article from the self-healing polymer of the invention.

### BRIEF DESCRIPTION OF THE DRAWINGS

FIG. 1. Photographic sequence of a pristine cylindrical sample of a polymer composition of the invention (i) which was cut in half (ii,iii). The two halves were then allowed to stand for 2 hours by simple contact (iv). After that time the material could be manually stretched without rupture (v and vi).

FIG. 2. Proposed interactions involved in the self-healing process of a polymer composition of the invention.

FIG. 3. FTIR spectra of reaction of PPG (IV) and IPDI at 70° C. at t=0 (black trace) and t=45 min. (grey trace), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 4. FTIR spectra of PPG (V) and IPDI at 60° C. at t=0 min (black trace) and t=70 min. (grey trace), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 5. FTIR spectra recorded for the synthesis of poly(urea-urethane) elastomer (XII) at different curing times (a=0; b=1 h; c=4 h; and d=16 h). At t=16 h, the NCO stretching band at 2264 cm⁻¹ completely disappeared and a new band corresponding to the urea appeared at 1650 cm⁻¹ in the form of a shoulder. The spectra have been shifted for clarity. A=absorbance; W=wavenumber.

FIG. 6. FTIR spectra recorded for the synthesis of poly(urea-urethane) elastomer (XIII) at different curing times (a=0; b=15 min; c=1 h; and d=16 h). At t=16 h, the NCO stretching band at 2264 cm⁻¹ completely disappeared and a new band corresponding to the urea appeared at 1650 cm⁻¹ in the form of a shoulder. The spectra have been shifted for clarity. A=absorbance; W=wavenumber.

FIG. 7. ¹H NMR spectra recorded for: a) bis(4-aminophenyl) disulfide (VI) and bis(4-methoxyphenyl) disulfide (VIII); b) metathesis kinetics of an equimolar mixture of (VI) and (VIII) at t=0, 1, 2, 12 and 22 hours in deuterated DMSO at room-temperature (inset shows the —OCH₃ protons); c) a completely equilibrated mixture of (VI) (25 mol %), (VIII) (25 mol %) and (XIV) (50 mol %) after 22 hours.

FIG. 8. ¹H NMR spectra recorded for: a) bis(p-tolyl) disulfide (VII) and bis(4-methoxyphenyl) disulfide (VIII); b) a completely equilibrated mixture of (VII) (25 mol %), (VIII) (25 mol %) and (XV) (50 mol %) at 24 hours (the two insets show the —OCH₃ and —CH₃ protons)

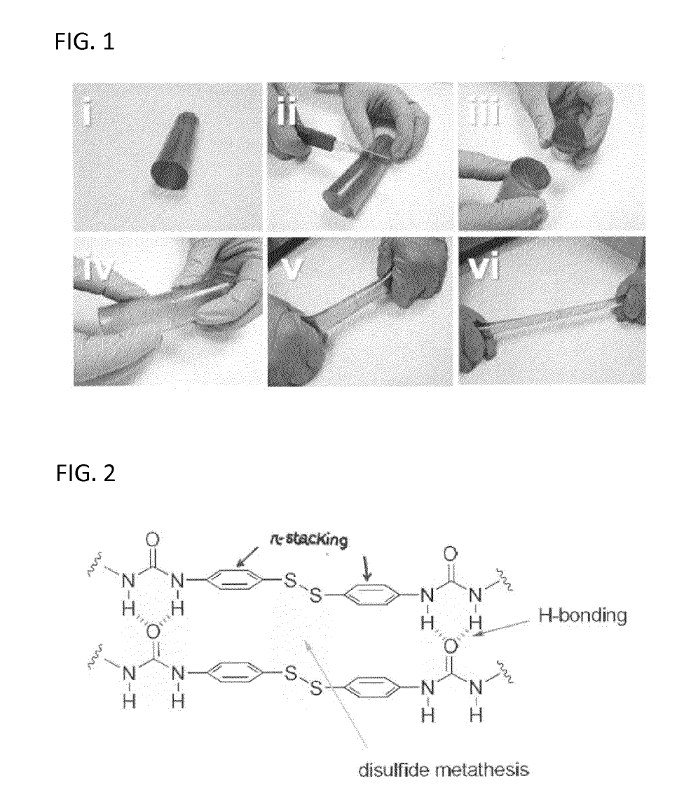

### DETAILED DESCRIPTION OF THE INVENTION

### Definitions

The term “polymer” refers to a macromolecule composed of many repeated subunits, known as monomers. Polymers, both natural and synthetic, are created via polymerization of many monomers. The polymer is composed of polymer chains, said chains being typically linear or branched.

The term “cross-linked polymer” (also referred to as a network or thermoset polymer) refers to a polymer wherein different polymeric chains (such as oligomers), which can be linear or branched, are linked through at least covalent bonds. In one embodiment, all the chains forming the polymer are cross-linked. In another embodiment, about from 10 to 85% of the chains forming the polymer are cross-linked.

The term “percentage (%) by weight” refers to the percentage of each ingredient of the polymer or mixture, when applicable, in relation to the total weight.

The term “functionality equal or higher than 2” when referred to the isocyanate-functionalised polymer or the amine-functionalised polymer, means that the polymer comprises at least two isocyanate or amine groups, respectively. In one embodiment, the isocyanate-functionalised polymer or the amine-functionalised polymer comprises from 2 to 100 isocyanate or amine groups, respectively. In another embodiment, the isocyanate-functionalised polymer or the amine-functionalised polymer comprises from 2 to 20 isocyanate or amine groups, respectively. In still another embodiment, the isocyanate-functionalised polymer or the amine-functionalised polymer comprises from 2 to 10 isocyanate or amine groups, respectively. In still another embodiment, the isocyanate-functionalised polymer or the amine-functionalised polymer comprises from 2 to 3 isocyanate or amine groups, respectively.

In the present invention, the terms “cured”/“curing” and “cross-linked”/“cross-linking” have the same meaning and can be used interchangeably.

The term “aryl” refers to a radical of one ring system with 1-3 rings which contains the number of carbon atoms specified in the description or claims, the rings being saturated, partially unsaturated, or aromatic; and being fused, bridged, or can contain different types of fusion; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen.

According to the present invention when the ring system is formed by “isolated” rings means that the ring system is formed by two, three or four rings and said rings are bound via a bond from the atom of one ring to the atom of the other ring. The term “isolated” also embraces the embodiment in which the ring system has only one ring. Illustrative non-limitative examples of known ring systems consisting of one ring are those derived from: cyclopropyl, cyclobutyl, cyclopentyl, cyclohexyl, cycloheptyl, cyclopropenyl, cyclobutenyl, cyclopentenyl, phenyl, and cycloheptenyl.

According to the present invention when the ring system has rings “totally fused”, means that the ring system is formed by two, three or four rings in which two or more atoms are common to two adjoining rings. Illustrative non-limitative examples are 1,2,3,4-tetrahydronaphthyl, 1-naphthyl, 2-naphthyl, anthryl, or phenanthryl.

According to the present invention when the ring system is “partially fused” it means that the ring system is formed by three or four rings, being at least two of said rings totally fused (i.e. two or more atoms being common to the two adjoining rings) and the remaining ring(s) being bound via a bond from the atom of one ring to the atom of one of the fused rings.

Throughout the description and claims, the term (C₁-C₂₀)alkyl shall be construed as straight or branched.

The term “molar ratio” refers to the relation of moles of amine:isocyanate reactive groups.

The term “room-temperature” denotes a temperature comprised from 10 to 35° C.

The parameter “tensile strength” is the maximum stress that a material can withstand while being stretched or pulled before failing or breaking. The parameter “elongation at break” is the maximum elongation that a material can withstand while being stretched or pulled before failing or breaking. These two parameters have been determined following UNE-EN-ISO 527 standard. Briefly, dumbbell-shaped specimens of normalized dimensions are stretched at an elongation rate of 500 mm min⁻¹ and the values of stress (MPa) and elongation (%) are measured and monitored until the specimen is broken.

The term “curing” refers to the toughening or hardening of a polymer material by cross-linking of polymer chains, brought about by chemical additives, ultraviolet radiation, electron beam or heat. In this process the resin viscosity drops initially upon the application of heat, passes through a region of maximum flow and begins to increase as the chemical reactions increase the average length and the degree of cross-linking between the constituent polymers. This process continues until a continuous 3-dimensional network of polymer chains is created—this stage is termed gelation. In terms of processability of the resin this marks an important watershed: before gelation the system is relatively mobile, after it the mobility is very limited, the micro-structure of the resin and the composite material is fixed and severe diffusion limitations to further cure are created. Thus, in order to achieve vitrification in the resin, it is usually necessary to increase the process temperature after gelation.

As it has been stated above, the present invention provides a self-healing polymer.

In one embodiment of the first aspect of the invention, P is a polyurethane polymeric chain.

In another embodiment, the polymer of the first aspect of the invention is a poly(urea-urethane).

In still another embodiment, R₂, R₂′, R₃ and R₃′ are —H.

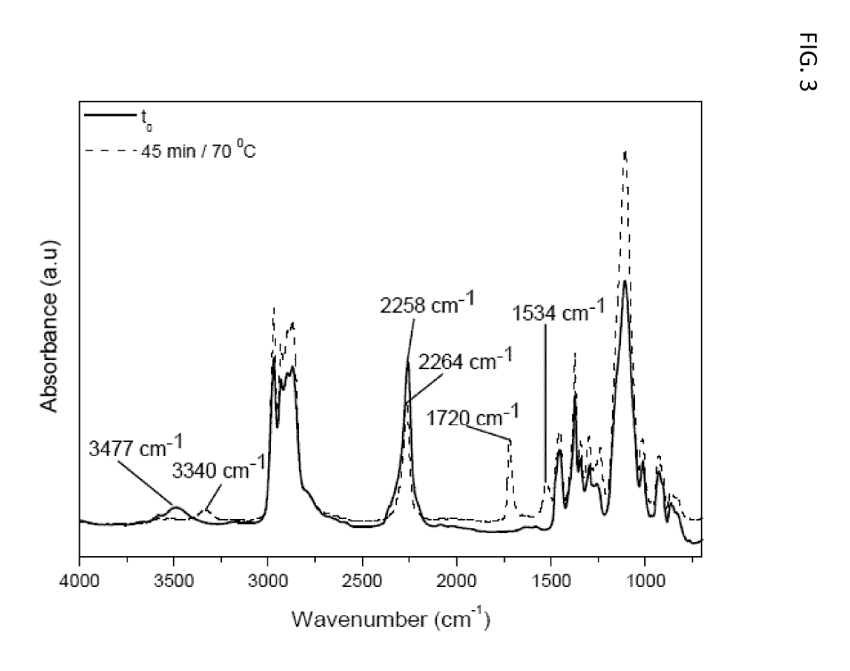

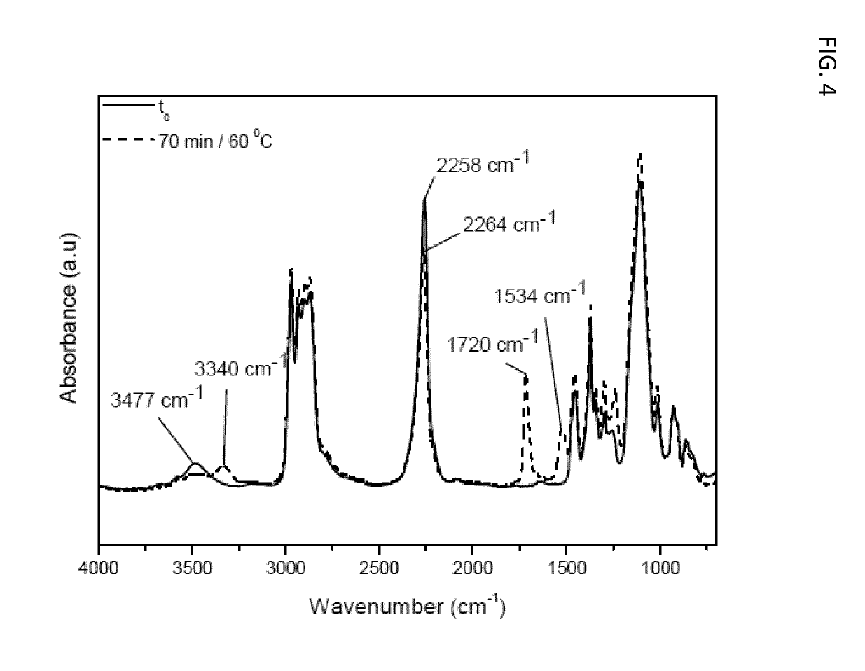

As shown below, the polymer composition exemplified (a poly(urea-urethane)) is a thermoset elastomer, which contains quadruple H-bonding interactions (as shown in FIG. 2) and is able to undergo catalyst-free aromatic disulfide metathesis. Such material presents near quantitative self-healing efficiency at room-temperature, without the need of any external intervention such as heat or light.

Such self-healing efficiency is remarkably high, and would not be expected by only considering the effect of the disulfide metathesis. It seems that the disulfide metathesis in the system of the invention is somehow accelerated or boosted. Without being bound to the theory, the remarkably efficient and fast self-healing ability of the poly(urea-urethane) polymer could be attributed to the two structural features, which are present in close proximity to the disulfide groups in the moiety of general formula (I): (a) two urea groups, capable of forming quadruple H-bonds with other urea groups, bringing the two disulfides (susceptible of being exchanged by metathesis) in close proximity, and (b) pi-pi stacking effects, which are attractive forces between the aromatic rings, which could further contribute to bring the two disulfides close to each other, thus accelerating the metathesis reaction. FIG. 2 shows the proposed interactions involved in the self-healing process of the material of the present invention.

Poly(urea-urethane)s can be formulated as monocomponent or bicomponent systems, wherein firstly it is prepared an isocyanate-functionalised polymer (by reacting a polyol resin with a diisocyanate or polyisocyanate component) which is crosslinked with polyamines (bicomponent systems) or by ambient humidity (monocomponent systems). The fact that poly(urea-urethane)s are widely used in industrial applications such as sealants, adhesives, paints and coatings, insulating foams, etc., makes the polymer composition of the invention very attractive for a fast and easy implementation in real industrial applications.

In another embodiment, n is 1.

In another embodiment, n is 1, R₂, R₂′, R₃ and R₃′ are —H, and the —NH—CO—NH— is in para-position with respect to the disulfide.

In yet another embodiment, m is 4, and R₁, and R₁′ are —H.

In still yet another embodiment, the unity of formula (I) is:

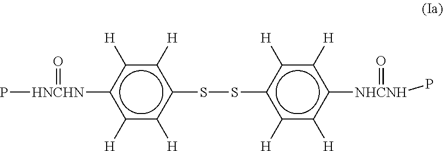

wherein P means a polyurethane polymer.

In still yet another embodiment, the elongation at break value of the cross-linked polymer is from 200 to 3600%.

In still yet another embodiment, the elongation at break value of the cross-linked polymer is from 1000 to 3500%.

In still yet another embodiment, the elongation at break value of the cross-linked polymer is from 1500 to 3200%.

In still yet another embodiment, the tensile strength value of the cross-linked polymer is from 0.5 to 1.0 MPa.

In a second aspect, the present invention provides a process for obtaining the polymer composition of the first aspect of the invention.

In one embodiment of the second aspect of the invention, the process comprises reacting an isocyanate-functionalised polymer with an aromatic disulfide of formula (II).

In another embodiment of the second aspect of the invention, the molar ratio between amine and isocyanate is 1.4.

In still another embodiment of the second aspect of the invention, the aromatic disulfide of formula (II) is one wherein n is 1.

In still another embodiment of the second aspect of the invention, the aromatic disulfide of formula (II) is one wherein Rₓ and Rₓ′ are —NH₂.

In still another embodiment of the second aspect of the invention, the aromatic disulfide of formula (II) is one wherein Rₓ and Rₓ′ are in para-position relative to the disulfide moiety.

In still another embodiment of the second aspect of the invention, the aromatic disulfide of formula (II) is one wherein Rₓ and Rₓ′ are —NH₂ and are in para-position.

In still another embodiment of the second aspect of the invention, m is 4 and R₁, and R₁′ are —H.

In another embodiment of the second aspect of the invention, the aromatic disulfide (II) used for the preparation of the self-healing elastomer is bis(4-aminophenyl) disulfide.

In another embodiment of the second aspect of the invention, the process comprises reacting an isocyanate-functionalised polymer with bis(4-aminophenyl) disulfide at a temperature comprised from 20 to 150° C. and wherein the molar ratio between amine and isocyanate groups is from 1.2 to 1.8.

In another embodiment of the second aspect of the invention, the reaction is performed at a temperature from 20 to 100° C.

In another embodiment of the second aspect of the invention, the reaction is performed at a temperature from 50 to 80° C.

In still another embodiment of the second aspect of the invention, the reaction is performed at a temperature from 55 to 65° C. Preferably, the reaction is performed at 60° C.

In another embodiment of the second aspect of the invention, the reaction is performed at a temperature from 50 to 80° C. for a period of time from 5 hours to 30 hours.

In still another embodiment of the second aspect of the invention, the reaction is performed at a temperature from 55 to 65° C. for a period of time from 8 hours to 24 hours.

The higher the temperature, the shorter the time required to complete the reaction. Thus, for instance, if the reaction temperature is 50° C., the time required would be about 30 hours and, if the reaction temperature is 65° C., the period of time would be about 8 hours.

In still another embodiment, the reaction is performed at 60° C. for a period of time from 10 to 20 hours. Preferably, the reaction is performed at 60° C. for 16 hours.

In another embodiment, the isocyanate-functionalised polymer is an isocyanate-functionalised polyurethane with a % NCO content from 0.1 to 5.0% (weight percent).

In another embodiment, the isocyanate-functionalised polymer is a tris- or a mixture of tris- and bis-isocyanate-terminated polymers.

In another embodiment, the isocyanate-functionalised polymer is a tris- or a mixture of tris- and bis-isocyanate-terminated polyurethane polymer.

These isocyanate terminated polymers can be any commercially available or can be synthesized following well-known methods (E. Delebecq, J.-P. et al., 2012; and U.S. Pat. No. 3,905,944)

Particularly, precursors which can be used for the preparation of polymers include, but are not limited to:
synthetic polymers: polyethylene glycol (PEG), polypropylene glycol (PPG), polytetramethylene glycol (PTMG), acrylates, methacrylates, polyesters, polycaprolactones, polyacids, polyvinyl alcohol (PVA), polydimethylsiloxane (PDMS), calcium polycarbophil, deacetylated gellan gum;
natural polymers: castor oil, soybean oil, polysaccharides such as chitosan, sodium or calcium carboxymethylcellulose, sodium alginate, condroitin sulphate, sodium hydroxypropylcellulose, hyaluronic acid, pectin; peptides, proteins, and oligonucleotides; polyisoprenes, and mixtures of the above mentioned synthetic and natural polymers or copolymers made there from.

Accordingly, in one embodiment, the precursor giving rise to the polymer chain is selected from the group consisting of calcium polycarbophil (a copolymer of acrylic acid and divinyl glycol), chitosan, sodium carboxymethylcellulose, calcium carboxymethylcellulose, sodium alginate, condroitin sulphate, sodium hydroxypropylcellulose, hyaluronic acid, pectin, poly(acrylic acid), poly(methacrylic acid), polyacrylamide, deacetylated gellan gum, polyethylene glycol, polypropylene glycol (PPG), castor oil, soybean oil, polyvinyl alcohol, polycaprolactone, and mixtures thereof.

In another embodiment, the precursor giving rise to the polymer chain is a non-water-soluble polymer whose T_{g} (glass transition temperature) is below room-temperature, such as PPG, castor oil or polyesters, among others.

In another embodiment, the precursor of the polymer is a tris-OH terminated PPG.

In another embodiment, the precursor is a mixture of bis- and tris-OH terminated PPG.

In another embodiment, the precursor is a mixture of bis-OH terminated PPG having an average molecular weight from 100 to 20000 g/mol and tris-OH terminated PPG having an average molecular weight from 150 to 20000 g/mol.

In another embodiment, the precursor is a mixture of bis-OH terminated PPG having an average molecular weight from 500 to 8000 g/mol and tris-OH terminated PPG having an average molecular weight from 1000 to 10000 g/mol.

In another embodiment, the precursor is a mixture of bis-OH terminated PPG having an average molecular weight of about 2000 g/mol and tris-OH terminated PPG having an average molecular weight of about 6000 g/mol.

In another embodiment, the PPG reacts with an isocyanate compound in order to obtain an isocyanate terminated polymer.

In one embodiment, the tris-OH terminated PPG reacts with an isocyanate compound in order to obtain a tris-isocyanate terminated polymer.

In another embodiment, the bis-OH terminated PPG reacts with an isocyanate compound in order to obtain a bis-isocyanate terminated polymer.

In another embodiment, the isocyanate compound is a diisocyanate compound which is selected from isophorone diisocyanate (IPDI), 4,4′-methylene diphenyl diisocyanate (MDI), toluene 2,4-diisocyanate (TDI), 1,4-tetramethylenediisocyanate, 1,6-hexamethylenediisocyanate (HDI), 1,1, o-decamethylenediisocyanate, 1,5-naphthalenediisocyanate, curnene2, 4-diisocyanate, 4-methoxy-1,3-phenylenediisocyanate; 4-chloro 1,3-phenylenediisocyanate, 4-bromo 1,3 phenylenediisocyanate, 4-ethoxy 1,3-phenylenediisocyanate, 2,4-diisocyanatodiphenylether, 5, 6-dimethyl 1, 3-phenylenediisocyanate, 2,4-dimethyl 1,3-phenylenediisocyanate, 4,4′-diisocyanatodiphenylether, benzidinediisocyanate, 4,6-dimethyl 1,3-phenylenediisocyanate, 9,10-anthracenediisocyanate, 4,4-diisocyanatodibenzyl, 3,3′-dimethyl-4,4-diisocyanatodiphenylmethane, 2,6diisocyanatostilbene, 3,3-dimethyl-4,4-diisocyanatodiphenyl, 3,3-dimethoxy-4,4′-diisocyanatodiphenyl, 1,4-anthracenediisocyanate, 2,5-fluorenediisocyanate, 1,5-naphthalenediisocyanate, 1,3-phenylenediisocyanate, 2,6-diisocyanatobenzfuran; 2,4-toluenetriisocyanate and 2,4,4-triisocyanatodiphenylether.

In another embodiment, the isocyanate compound is isophorone diisocyanate (IPDI).

In one embodiment, the tris-OH terminated PPG reacts with IPDI in order to obtain a tris-isocyanate terminated polymer.

In another embodiment, the bis-OH terminated PPG reacts with IPDI in order to obtain a bis-isocyanate terminated polymer.

In one embodiment, the tris-OH terminated PPG having an average molecular weight from about 1000 to 10000 g/mol reacts with IPDI in order to obtain a tris-isocyanate terminated polymer.

In another embodiment, the tris-OH terminated PPG having an average molecular weight of about 6000 g/mol reacts with IPDI in order to obtain a tris-isocyanate terminated polymer.

In one embodiment, the bis-OH terminated PPG having an average molecular weight from about 500 to 8000 g/mol reacts with IPDI in order to obtain a bis-isocyanate terminated polymer.

In one embodiment, the bis-OH terminated PPG having an average molecular weight of 2000 g/mol reacts with IPDI in order to obtain a bis-isocyanate terminated polymer.

In another embodiment of the second aspect of the invention, the process comprises reacting a tris-isocyanate terminated polymer, or a mixture of tris- and bis-isocyanate terminated polymers, with bis(4-aminophenyl) disulfide at a temperature comprised from 10 to 150° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 10 to 60% by weight and the tris-isocyanate terminated polymer content is from 90 to 40%, with bis(4-aminophenyl) disulfide at a temperature comprised from 10 to 150° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount from 9 to 54% by weight, tris-isocyanate terminated polymer in an amount from 81 to 36% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

Solvents, plasticizers, pigments, organic or inorganic fillers, adhesion promoter, UV-stabilizers, rheology modifiers, flame-retardant additives, are those used in the polymer manufacturing and are well-known for those skilled in the art. Reference is made, for instance, to Harper C. A., “Modern Plastics Handbook”, Chapter 4, 1999, pages 4.1-5.0; G. Wypych, “Handbook of Plasticizers”, Ed.: ChemTec Publishing, Chapter 11, 2004, pages 273-379; and Bolgar M. et al. “Handbook for the chemical analysis of plastics and polymer additives”, Ed.: CRC Press, Chapters 3 to 9, 2008, pages 27-303.

In another embodiment of the second aspect of the invention, the process comprises reacting: (a) a mixture comprising bis-isocyanate terminated polymer in an amount from 6 to 36% by weight, tris-isocyanate terminated polymer in an amount from 54 to 24% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount from 3 to 18% by weight, tris-isocyanate terminated polymer in an amount from 27 to 12% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 20 to 40% by weight and the tris-isocyanate terminated polymer content is from 80 to 60%, with bis(4-aminophenyl) disulfide at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount from 18 to 36% by weight, tris-isocyanate terminated polymer in an amount from 72 to 54% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount from 12 to 24% by weight, tris-isocyanate terminated polymer in an amount from 48 to 36% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount from 6 to 12% by weight, tris-isocyanate terminated polymer in an amount from 24 to 18% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 30% by weight and the tris-isocyanate terminated polymer content is from 70%, with bis(4-aminophenyl) disulfide at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount of 27% by weight, tris-isocyanate terminated polymer in an amount of 63% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount of 18% by weight, tris-isocyanate terminated polymer in an amount of 42% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting: (a) a mixture comprising bis-isocyanate terminated polymer in an amount of 9% by weight, tris-isocyanate terminated polymer in an amount of 27% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more component(s) being 100% by weight; with (b) bis(4-aminophenyl) disulfide, at a temperature comprised from 10 to 150° C. and wherein the molar ratio between the amine and isocyanate reactive groups is from 1.2 to 1.8.

In another embodiment of the second aspect of the invention, the process comprises reacting a primary or secondary amine functionalised polymer with an aromatic disulfide of formula (III).

In another embodiment of the second aspect of the invention, the aromatic disulfide of formula (III) is one wherein n is 1.

In still another embodiment of the second aspect of the invention, the aromatic disulfide of formula (III) is one wherein R_{z} and R_{z}′ are in para-position relative to the disulfide.

In still another embodiment of the second aspect of the invention, the aromatic disulfide of formula (III) is one wherein m is 4 and R₁, and R₁′ are —H.

In another embodiment, the amine functionalised polymer is a tris- or a mixture of tris- and bis-amine terminated polymers.

These amine terminated polymers (either primary or secondary) can be any commercially available or can be synthesized following well-known methods (Zhang L, et al., 2013; Fischer A., et al., 1999; Roundhill D. M., 1992)

In another embodiment of the second aspect of the invention, the process comprises reacting a mixture consisting of tris-amine terminated polymer and a bis-amine terminated polymer, wherein the bis-amine terminated polymer content in the mixture is from 10 to 60% by weight and the tris-amine terminated polymer content is from 90 to 40%, with bis(4-isocyanatephenyl) disulfide at a temperature comprised from −30 to 50° C. and wherein the molar ratio between the amine and isocyanate reactive groups is from 1.2 to 1.8.

In another embodiment of the second aspect of the invention, the process comprises reacting (a) a tris-amine terminated polymer, or a mixture comprising bis-amine terminated polymer in an amount from 9 to 54% by weight, tris-amine terminated polymer in an amount from 81 to 36% by weight, and one or more components selected from the group consisting of: solvents, plasticizers, pigments, organic or inorganic fillers, adhesion promoter, UV-stabilizers, rheology modifiers, flame-retardant additives or other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount from 6 to 36% by weight, tris-amine terminated polymer in an amount from 54 to 24% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount from 3 to 18% by weight, tris-amine terminated polymer in an amount from 27 to 12% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting a mixture consisting of tris-amine terminated polymer and a bis-amine terminated polymer, wherein the bis-amine terminated polymer content in the mixture is from 20 to 40% by weight and the tris-amine terminated polymer content is from 80 to 60%, with bis(4-isocyanatephenyl) disulfide at a temperature comprised from −30 to 50° C. and wherein the molar ratio between the amine and isocyanate reactive groups is from 1.2 to 1.8.

In another embodiment of the second aspect of the invention, the process comprises reacting (a) a tris-amine terminated polymer, or a mixture comprising bis-amine terminated polymer in an amount from 18 to 36% by weight, tris-amine terminated polymer in an amount from 72 to 54% by weight, and one or more components selected from the group consisting of: solvents, plasticizers, pigments, organic or inorganic fillers, adhesion promoter, UV-stabilizers, rheology modifiers, flame-retardant additives, and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount from 12 to 24% by weight, tris-amine terminated polymer in an amount from 48 to 36% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount from 6 to 12% by weight, tris-amine terminated polymer in an amount from 24 to 18% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting a mixture consisting of tris-amine terminated polymer and a bis-amine terminated polymer, wherein the bis-amine terminated polymer content in the mixture is 30% by weight and the tris-amine terminated polymer content is 70%, with bis(4-isocyanatephenyl) disulfide at a temperature comprised from −30 to 50° C. and wherein the molar ratio between the amine and isocyanate reactive groups is from 1.2 to 1.8.

In another embodiment of the second aspect of the invention, the process comprises reacting (a) a tris-amine terminated polymer, or a mixture comprising bis-amine terminated polymer in an amount of 27% by weight, tris-amine terminated polymer in an amount of 63% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount of 18% by weight, tris-amine terminated polymer in an amount of 42% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting (a) a tris-amine terminated polymer, or a mixture comprising bis-amine terminated polymer in an amount of 9% by weight, tris-amine terminated polymer in an amount of 27% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) bis(4-isocyanatephenyl) disulfide at a temperature comprised from −30 to 50° C. and wherein the molar ratio between the amine and is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 20 to 100° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 50 to 80° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 55 to 65° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature of 60° C. and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 50 to 80° C., for a period of time from 5 to 30 hours, and wherein the molar ratio between the amine and isocyanate reactive groups is from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% by weight and the tris-isocyanate terminated polymer content is from 70%, with bis(4-aminophenyl) disulfide at a temperature comprised from 55 to 65° C., for a period of time from 8 to 24 hours, and wherein the molar ratio between the amine and isocyanate reactive groups is from 1.2 to 1.8.

In still another embodiment, the reaction is performed at 60° C.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 30% by weight and the tris-isocyanate terminated polymer content is 70%, with bis(4-aminophenyl) disulfide at a temperature of 60° C., for a period of time from 10 to 20 hours, and wherein the molar ratio between the amine and isocyanate reactive groups is from 1.2 to 1.8. Preferably, the reaction is performed at 60° C. for 16 hours.

In another embodiment of the second aspect of the invention, the molar ratio between the amine and isocyanate reactive groups is 1.4.

Furthermore, the present invention covers all possible combinations of particular and preferred groups described hereinabove.

In another aspect, the present invention provides an article manufactured with the self-healing polymer of the first aspect of the invention.

In a fourth aspect the present invention provides the use of the polymer composition of the first aspect of the invention as an adhesive. In this aspect, the polymer composition of the first aspect of the invention can be formulated as a two-component reactive system, wherein one of the components is based on an isocyanate- or amine-functionalised polymer and the second component is a crosslinker based on an aromatic disulfide with amine or isocyanate functionality, respectively. Prior to application, the two components have to be mixed and well homogenized, and then the mixture is applied as an adhesive. After the application, the system must be allowed to cure in order to become solid and to perform its adhesive properties.

In another aspect, the present invention provides the use of the polymer composition as defined in the first aspect of the invention as construction sealant. In this aspect, the polymer composition of the first aspect of the invention can be formulated as a two-component reactive system wherein one of the components is based on an isocyanate- or amine-functionalised polymer and the second component is a crosslinker based on an aromatic disulfide with amine or isocyanate functionality, respectively. Prior to application, the two components have to be mixed and well homogenized, and then the mixture is applied as a sealant. After the application, the system must be allowed to cure in order to obtain an elastomeric solid able to perform its sealing properties.

Due to the properties shown, the polymer of the invention can be used as an self-healing material for the manufacturing of: (a) binding material for the manufacturing of anti-vibration mats for the railway sector; (b) rubber watchstrap for watches; (c) self-healing elastic bands; (d) self-healing septums, to store unstable and/or dangerous liquids; (d) extendable hoses without the need for unions; (e) certain layers in the interior of tires; (f) self-healing flexible screens; (g) self-healing polyurethane foam; (h) paint in powder. Class A; (i) self-healing joints for the aerospace industry; (j) adhesives for hybrid joints or not, in the transport sector (railway, . . . ); (k) interior surfaces in automobiles; (l) coverings for roofs, walls, floors, home appliances, etc.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples are provided by way of illustration, and they are not intended to be limiting of the present invention. Furthermore, the present invention covers all possible combinations of particular and preferred embodiments described herein.

### EXAMPLES

### 1. Materials and Methods

Poly(propylene glycol)s (PPG) of formula (IV) (Mn 6000) and (V) (Mn 2000) were purchased from Bayer Materials Science. Isophorone diisocyanate (IPDI, 98%), dibutyltin dilaurate (DBTDL, 95%), bis(4-aminophenyl) disulfide (VI) (98%), bis(p-tolyl) disulfide (VII) (98%), bis(4-methoxyphenyl) disulfide (VIII) (97%), 4,4′-ethylenedianiline (IX) (>95%) and tetrahydrofurane (THF) were purchased from Sigma-Aldrich and were used as received.

Fourier transform infrared (FTIR) spectra were registered in a Nicolet Avatar 360 spectrophotometer, using KBr disks compressed to 2 Ton cm⁻² for 2 min as support. ¹H NMR spectra were registered in a Bruker AVANCE III 500 MHz spectrometer. Mechanical testing was performed using INSTRON 3365 Long travel Elastomeric Extensometer controlled by Bluehill Lite software. Tensile strength and elongation at break measurements were carried out according to UNE-EN-ISO 527 standard using dumbbell type test specimens and an elongation rate of 500 mm min⁻¹.

### Example 1

### Synthesis of Tris-Isocyanate-Terminated Polyurethane Polymer (X)

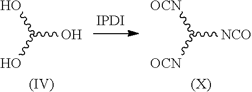

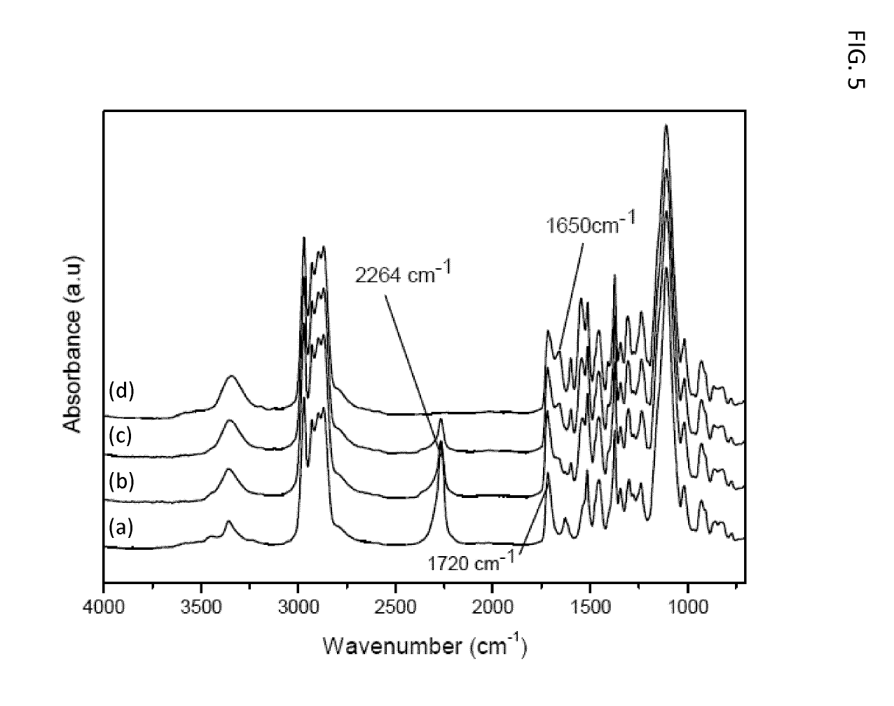

A mixture of poly(propylene glycol) (IV) (390 g, 65 mmol) and isophorone diisocyanate (IPDI) (45.45 g, 204.5 mmol) were fed into a 1 L glass reactor equipped with mechanical stirrer and a vacuum inlet. The mixture was degassed by stirring under vacuum while heating at 70° C. for 10 min. Then dibutyltin dilaurate (DBTDL) (50 ppm) was added and the mixture was further stirred under vacuum at 70° C. for 45 minutes. The reaction was monitored by FTIR spectroscopy (FIG. 3). The resulting tris-isocyanate terminated polymer (X) was obtained in the form of a colourless liquid and stored in a tightly closed glass bottle. Yield: 398 g, 92%.

### Example 2

### Synthesis of Bis-Isocyanate-Terminated Polyurethane Polymer (XI)

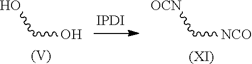

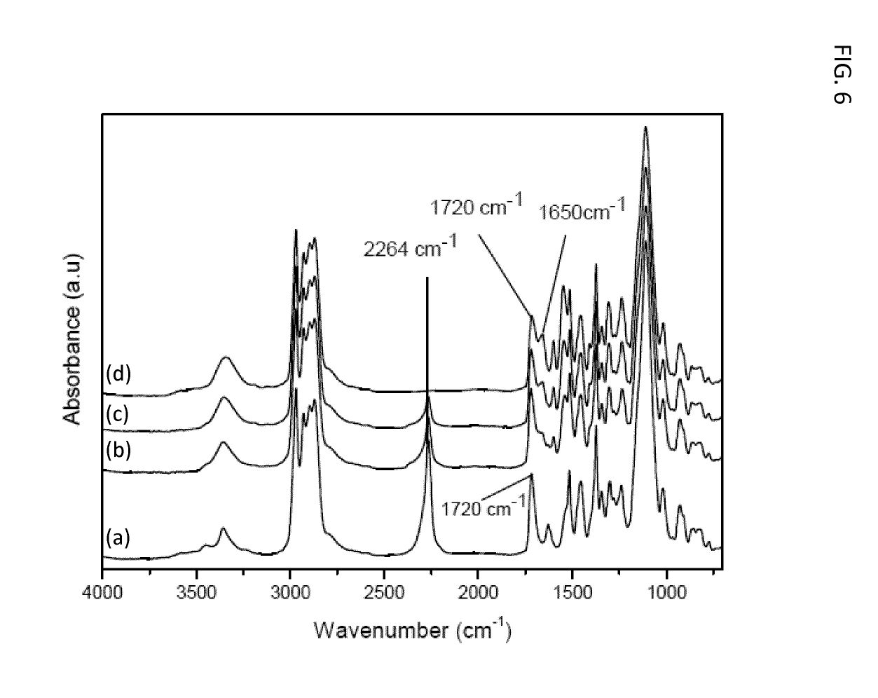

A mixture of poly(propylene glycol) (V) (250 g, 125 mmol) and IPDI (55.5 g, 250 mmol) were fed into a 1 L glass reactor equipped with mechanical stirrer and a vacuum inlet. The mixture was degassed by stirring under vacuum while heating at 60° C. for 10 min. Then DBTDL (50 ppm) was added and the mixture was further stirred under vacuum at 60° C. for 70 minutes. The reaction was monitored by FTIR spectroscopy (FIG. 4). The resulting bis-isocyanate terminated polymer (XI) was obtained in the form of a colourless liquid and stored in a tightly closed glass bottle. Yield: 301 g, 98%.

### Example 3

### Synthesis of Self-Healing Poly(Urea-Urethane) Elastomer (XII)

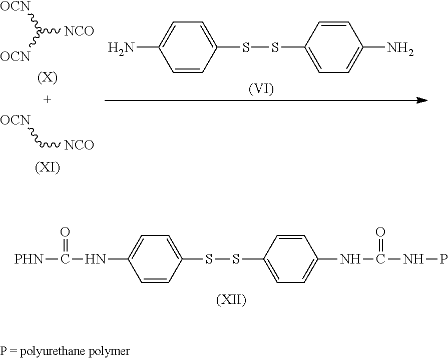

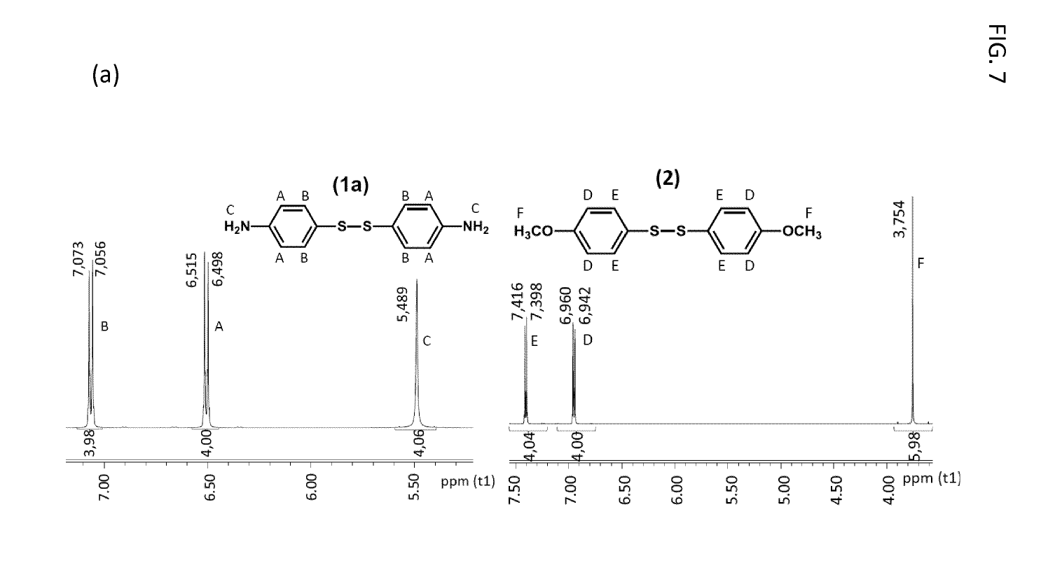

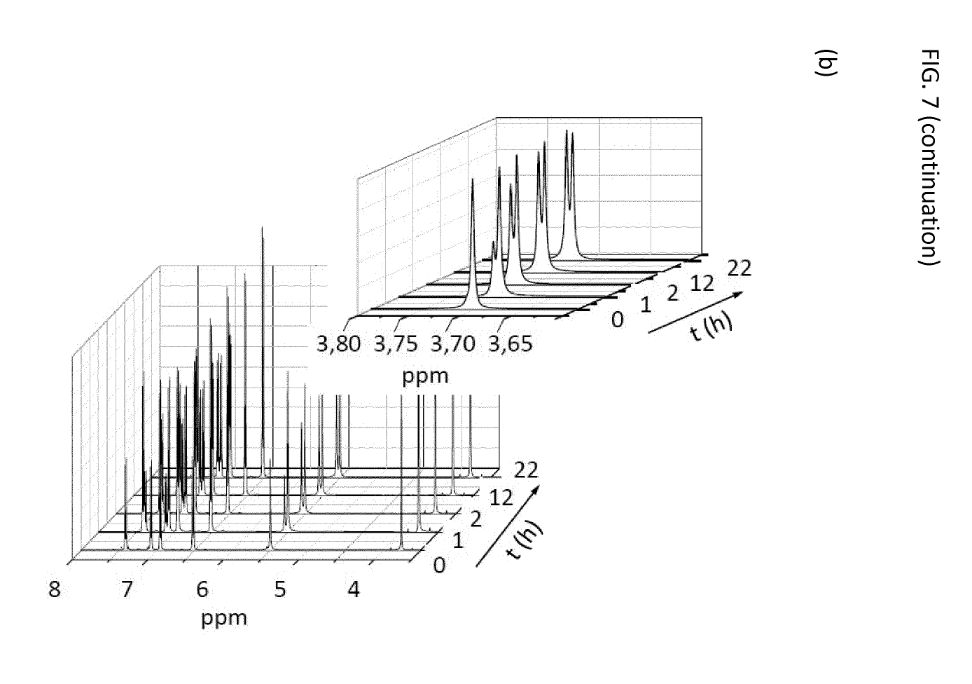

Isocyanate-terminated polyurethane polymers (X) (35 g) and (XI) (15 g) were mixed in a 250 mL glass reactor. Then, a solution of the curing agent (VI) (5.12 g, 1.4 equivalents of amine with respect to NCO groups) in THF (3 mL) was added. The mixture was degassed under vacuum for 15 minutes and the mixture was placed on to an open mold. The curing was allowed to proceed for 16 h at 60° C. and was monitored by FTIR spectroscopy (FIG. 5). Poly(urea-urethane) polymer (XII) was obtained as a yellowish transparent elastomeric material. Yield: 49 g, 89%.

### Example 4

### Synthesis of Reference Poly(Urea-Urethane) Elastomer (XIII)

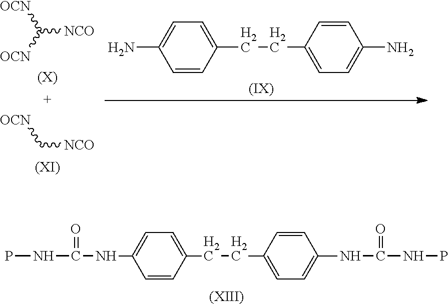

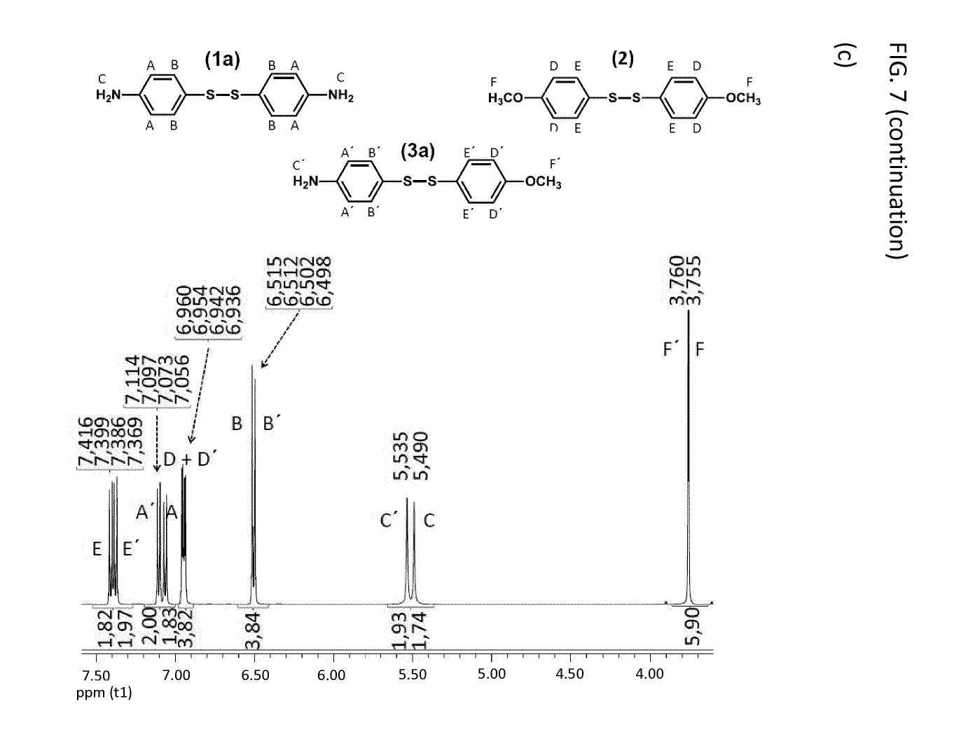

Isocyanate-terminated polyurethane polymers (X) (35 g) and (XI) (15 g) were mixed in a 250 mL glass reactor. Then, a solution of (IX) (4.41 g, 1.4 equivalents of amine with respect to NCO groups) in THF (5 mL) was added. The mixture was degassed under vacuum for 15 minutes and the mixture was placed on to an open mold. The curing was allowed to proceed for 16 h at 60° C. and was monitored by FTIR spectroscopy (FIG. 6). Poly(urea-urethane) (XIII) was obtained as a yellowish transparent elastomeric material. Yield: 52 g, 94%.

### Example 5

### Measurement of Tensile Strength and Elongation at Break

A 2 mm thick film of the poly(urea-urethane) elastomer (XII) was prepared following the same preparation method as in Example 3 and placing the reactive mixture in a 2 mm thick mold. The curing was allowed to proceed for 16 h at 60° C. and the solid film was then cut in the form of dumbbell-shaped specimens, in order to perform tensile strength measurements. Some of the specimens were mechanically tested as pristine samples. The rest of them were tested after being cut in half and then mended by simple contact at room-temperature for different periods of time (1 h, 2 h, 12 h and 24 h). Tensile strength tests were performed according to ISO 527 and stress vs. elongation curves were monitored. Briefly, dumbbell-shaped specimens of normalized dimensions are stretched at an elongation rate of 500 mm min⁻¹ and the values of stress (MPa) and elongation (%) are measured and monitored until the specimen is broken. The results are summarized in Table 1.

TABLE 1

| | Tensile | Elongation |
|---|---|---|
| Sample | strength (MPa) | at break (%) |
| Pristine | 0.81 | 3100 |
| Mended 1 h | 0.52 | 2200 |
| Mended 2 h | 0.67 | 2600 |
| Mended 12 h | 0.72 | 2800 |
| Mended 24 h | 0.77 | 3015 |

### Example 6

### Study of the Self-Healing Mechanisms

### A) Model Aromatic Disulfide Metathesis

As a model metathesis reaction, the present inventors studied the equilibration of equimolar amounts of (VI) and bis(4-methoxyphenyl) disulfide (VIII) in deuterated DMSO:

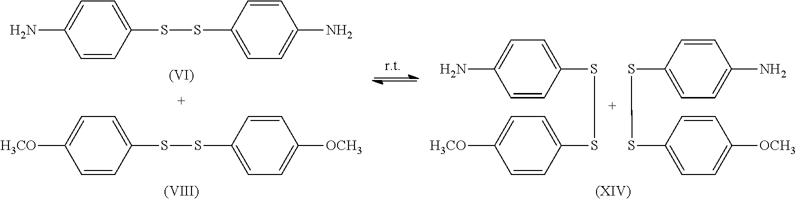

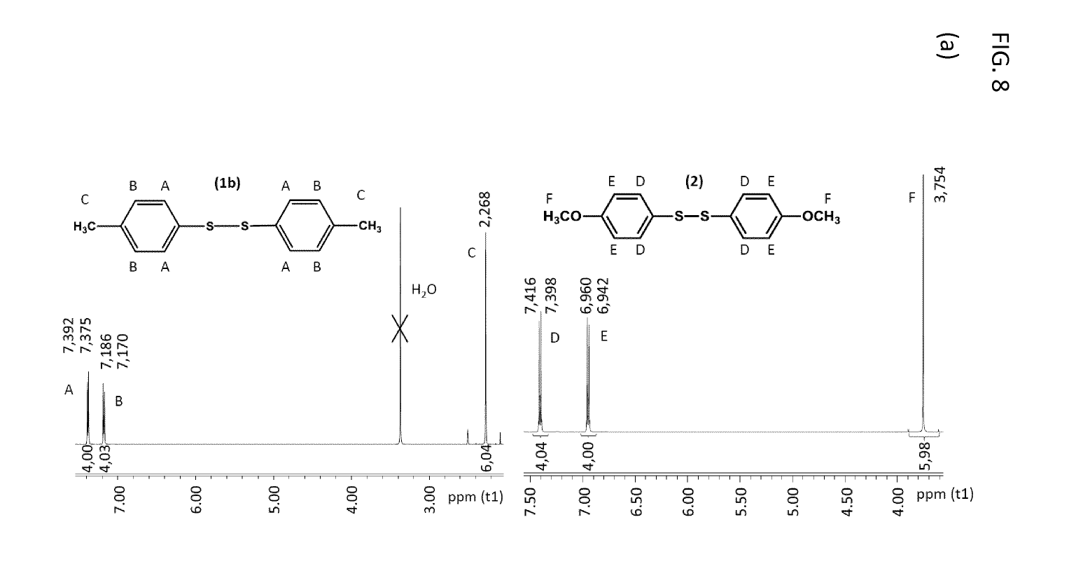

When the reaction was performed in the presence of 0.1 equivalents of NEt₃, the equilibrium was reached in less than 1 hour. However, without the addition of any NEt₃, metathesis started in less than 1 hour, achieving the equilibrium in 22 hours, as shown by ¹H NMR (FIG. 7), where a mixture of (VI) (25 mol %), (VIII) (25 mol %) and (XIV) (50 mol %) was obtained. In order to corroborate that the reaction did not occur by a self-catalysis effect of primary aromatic amines present in (VI), the same experiment was performed using (VII) and (VIII), without NEt₃:

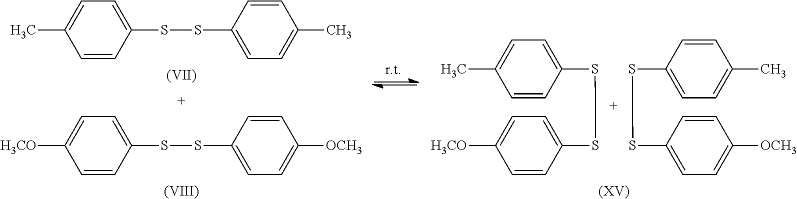

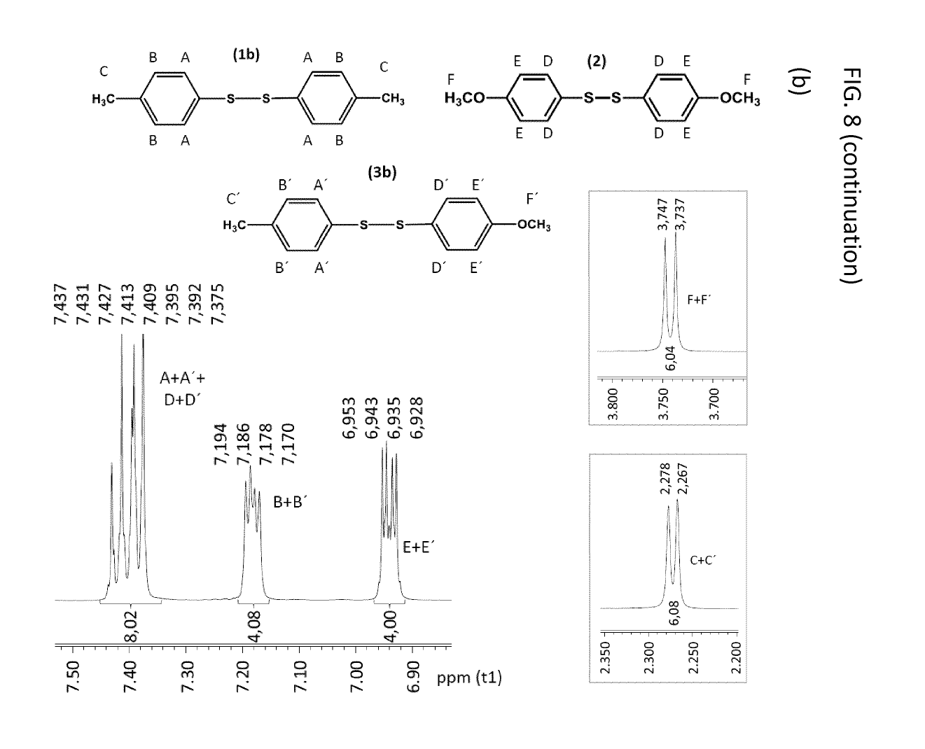

Surprisingly, when mixing equimolar amounts of (VII) and (VIII), equilibration was also achieved after 24 hours, corroborating that the exchange reaction occurs without the need of any catalyst (FIG. 8).

### B) Quadruple H-Bonding Interactions

In order to study the contribution from the two types of interactions involved in the self-healing mechanism (i.e., the constant exchange of aromatic disulfide and the formation of quadruple H-bond), the self-healing efficiency of poly(urea-urethane) elastomer (XIII) was studied as a reference material with no disulfide bonds. Pristine samples of reference material poly(urea-urethane) elastomer (XIII) exhibited a tensile strength of 0.84±0.05 MPa and an elongation at breaking point of 2156±50% (Table 2). The mended samples of poly(urea-urethane) elastomer (XIII) (r.t., 1, 2, 12 and 24 h) showed a maximum tensile strength of 0.43±0.05 MPa and an elongation at breaking point of 1657±50%. Such values were already achieved after 1 hour, and did not improve with higher healing times. This indicates a maximum healing efficiency of 51%, which must be attributed to the contribution of the quadruple H-bond between the urea groups.

On the other hand, poly(urea-urethane) elastomer (XII) recovered 62% of its initial tensile strength at 1 h, but already achieved an 80% after 2 hours. After 24 hours, the healing was practically quantitative. These results suggest that H-bonds would give rise to a healing efficiency of around 50% in a short period of time, which is common for both systems. Thus, the further quantitative healing shown by XII would be attributed to the effect of the aromatic disulfide metathesis.

TABLE 2

| | Tensile | Elongation |
|---|---|---|
| Sample | strength (MPa) | at break (%) |
| Pristine | 0.84 | 2156 |
| Mended 1 h | 0.39 | 1620 |
| Mended 2 h | 0.42 | 1640 |
| Mended 12 h | 0.41 | 1630 |
| Mended 24 h | 0.43 | 1657 |

### REFERENCES CITED IN THE APPLICATION

E. Delebecq, et al., “On the Versatility of Urethane/Urea Bonds: Reversibility, Blocked Isocyanate, and Non-isocyanate Polyurethane”, Chem. Rev., 2012, v. 113, p. 80-118;
Zhang L., et al., “Synthesis of an amine terminated polyether: effects of the activation conditions on a Raney nickel catalyst”, React Kinet Catal. 2013, v. 108, pp 139-149;
Fischer A., et al., “Cobalt-Catalyzed Amination of 1,3-Propanediol: Effects of Catalyst Promotion and Use of Supercritical Ammonia as Solvent and Reactant”, J Catal, 1999, v. 183, p. 373-383;
Roundhill D. M., et al. “Transition Metal and Enzyme Catalyzed Reactions involving Reactions with Ammonia and Amines”, Chem Rev, 1992, v. 92(1); U.S. Pat. No. 3,905,944; WO2010128007;
Harper C. A., “Modern Plastics Handbook”, Chapter 4, 1999, pages 4.1-5.0;
G. Wypych, “Handbook of Plasticizers”, Ed.: ChemTec Publishing, Chapter 11, 2004, pages 273-379; and
Bolgar M. et al. “Handbook for the chemical analysis of plastics and polymer additives”, Ed.: CRC Press, Chapters 3 to 9, 2008 pages 27-303.

1. A self-healing cross-linked polymer comprising units of formula (I) 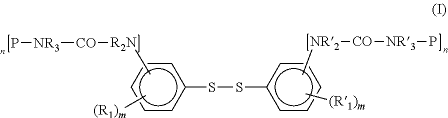
wherein
P is a polymeric chain,
R₁ and R₁′ are independently selected from the group consisting of: —H, (C₁-C₂₀)alkyl, (C₅-C₁₄)aryl, —OR₄, —(CO)R₅, —O(CO)R₆, —(SO)R₇, —NH—CO—R₈, —COOR₉, —NR₁₀R₁₁, —NO₂, and halogen;
R₂, R₂′, R₃ and R₃′ are independently selected from the group consisting of: —H, (C₁-C₂₀)alkyl and (C₅-C₁₄)aryl;
R₄ to R₁₁ are the same or different, and are selected from the group consisting of: —H, (C₁-C₂₀)alkyl, and (C₅-C₁₄)aryl;
m is from 3 to 4;
n is from 1 to 2; provided that n+m is 5;
wherein the polymer has H-bonding interactions between the urea groups and is able to undergo catalyst free aromatic disulfide metathesis at room-temperature, and wherein the polymer has a tensile strength value from 0.5 to 1.5 MPa and an elongation at break value higher than 200% at room-temperature.

2. The polymer according to claim 1, wherein the elongation at break value of the cross-linked polymer is from 1000 to 3500%.

3. The polymer according to claim 1, wherein P is a polyurethane polymer.

4. The polymer according to claim 1, which is a poly(urea-urethane).

5. The polymer according to claim 1, wherein n is 1 and the urea biradical is in para-position relative to the disulfide group.

6. The polymer according to claim 1, wherein m is 4 and R₁, R₁′, R₂, R₂′, R₃ and R₃′ are —H.

7. The polymer according to claim 1, wherein the unit of formula (I) is 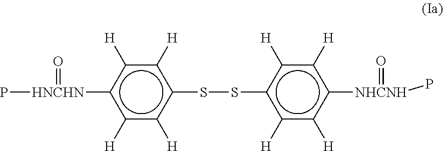
wherein P means a polyurethane polymer.

8. A process for preparing a self-healing polymer as defined in claim 1, comprising reacting an isocyanate-functionalised polymer with functionality equal or higher than 2 with an aromatic disulfide of formula (II) 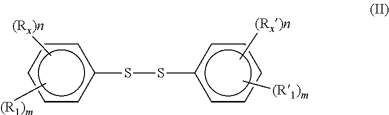
wherein
R₁, R₁′, n and m are as defined in claim 1,
Rₓ and Rₓ′ are the same or different and represents —NHR_{y},
R_{y} is selected from the group consisting of —H, (C₁-C₂₀)alkyl, —and (C₅-C₁₄)aryl;
or alternatively,
reacting a primary or secondary amine-functionalised polymer with amine functionality equal or higher than 2 with an aromatic disulfide of formula (III) 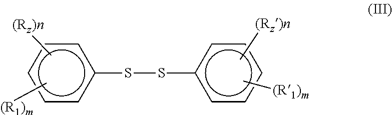
wherein
R₁, R₁′, n and m are as defined in claim 1,
R_{z} and R_{z}′ represents —N(CO),
the reaction being performed, in any of the alternatives, at a temperature comprised from −30 to 200° C. and wherein the molar ratio between amine and isocyanate groups is from 1.2 to 1.8.

9. The process according to claim 8, wherein the isocyanate-functionalised polymer or the amine-functionalised polymer comprises from 2 to 100 isocyanate or amine groups, respectively.

10. The process according to claim 9, wherein the isocyanate-functionalised polymer or the amine-functionalised polymer comprises from 2 to 10 isocyanate or amine groups, respectively.

11. The process according to claim 8, wherein the molar ratio between amine and isocyanate groups is 1.4.

12. A self-healing cross-linked polymer obtained by the process as defined in claim 8.

13. An article of manufacture comprising the self-healing polymer network according to claim 1 or 12.

14. The article of manufacture of claim 13, wherein the article of manufacture is an adhesive.

15. The article of manufacture of claim 13, wherein the article of manufacture is a construction sealant.
